(19) United States
(12) Patent Application Publication
(10) Pub. No.: US 2019/0257096 A1
(43) Pub. Date: Aug. 22, 2019

(54) HVAC UNIT CATWALK SYSTEMS AND METHODS

(71) Applicant: Johnson Controls Technology Company, Auburn Hills, MI (US)

(72) Inventors: Curtis W. Caskey, Dallastown, PA (US); Kevin R. Stockton, York, PA (US); Kristen Velez-Diaz, York, PA (US); Julie A. Shirey, York, PA (US); Rajiv K. Karkhanis, York, PA (US); Brian J. Zinn, Lewisberry, PA (US); Troy E. Smith, Dallastown, PA (US)

(21) Appl. No.: 15/971,711

(22) Filed: May 4, 2018

Related U.S. Application Data
(60) Provisional application No. 62/634,056, filed on Feb. 22, 2018.

(51) Int. Cl. E04G 3/24; F24F 13/00; E04G 3/20; E04G 5/14; E06C 1/39

(52) U.S. Cl. CPC E04G 3/243; F24F 13/00; F24F 2221/16; E04G 5/14; E06C 1/39; E04G 3/20

(57) ABSTRACT

The present disclosure relates to a heating, ventilating, and air conditioning (HVAC) apparatus including a catwalk pivotally attached to the HVAC apparatus such that the catwalk is configured to be folded toward the HVAC apparatus.

### CROSS REFERENCE TO RELATED APPLICATION

This application is a Non-Provisional application claiming priority to U.S. Provisional Application No. 62/634,056, entitled “HVAC UNIT CATWALK SYSTEMS AND METHODS,” filed Feb. 22, 2018, which is hereby incorporated by reference in its entirety for all purposes.

### BACKGROUND

The present disclosure relates generally to heating, ventilating, and air conditioning systems. A wide range of applications exist for heating, ventilating, and air conditioning (HVAC) systems. For example, residential, light commercial, commercial, and industrial systems are used to control temperatures and air quality in residences and buildings. Such systems often are dedicated to either heating or cooling, although systems are common that perform both of these functions. Very generally, these systems operate by implementing a thermal cycle in which fluids are heated and cooled to provide the desired temperature in a controlled space, typically the inside of a residence or building. Similar systems are used for vehicle heating and cooling, and as well as for general refrigeration. In many HVAC systems, an HVAC unit may be positioned on a rooftop. In such circumstances, technicians or other personnel may utilize a catwalk to move about the HVAC unit to perform various operations such as installation and maintenance.

### SUMMARY

The present disclosure relates to a heating, ventilating, and air conditioning (HVAC) apparatus including a catwalk pivotally attached to the HVAC apparatus such that the catwalk is configured to be folded toward the HVAC apparatus.

The present disclosure also relates to a heating, ventilating, and air conditioning (HVAC) system including an HVAC apparatus and a catwalk configured to couple to a base of the HVAC unit. The catwalk includes a plurality of platforms and a plurality of support members pivotally coupled to the HVAC apparatus and configured to couple the plurality of platforms to the HVAC unit.

The present disclosure further relates to a heating, ventilating, and air conditioning (HVAC) system including an HVAC apparatus having a base and a catwalk coupled to the base of the HVAC unit. The catwalk is configured to be pivoted between a first position and a second position about a hinge coupled to the base.

### DRAWINGS

FIG. 1 is a perspective view a heating, ventilating, and air conditioning (HVAC) system for building environmental management, in accordance with embodiments described herein;

FIG. 2 is a perspective view of the HVAC unit of FIG. 1, in accordance with embodiments described herein;

FIG. 3 is a perspective view of a residential heating and cooling system, in accordance with embodiments described herein;

FIG. 4 is a schematic diagram of a vapor compression system that may be used in the HVAC system of FIG. 1 and the residential heating and cooling system FIG. 3, in accordance with embodiments described herein;

FIG. 5 is a perspective view of an HVAC unit that includes a catwalk, in accordance with embodiments described herein;

FIG. 6 is a perspective view of an HVAC unit that includes a catwalk, in accordance with embodiments described herein;

FIG. 7 is a perspective view of an HVAC unit that includes a catwalk, in accordance with embodiments described herein;

FIG. 8 is a perspective view of an HVAC unit that includes a catwalk, in accordance with embodiments described herein; and

FIG. 9 is a perspective view of an HVAC unit that includes a catwalk, in accordance with embodiments described herein.

### DETAILED DESCRIPTION

The present disclosure is directed to heating, ventilating, and air conditioning (HVAC) systems and units, such as rooftop HVAC units, that include a catwalk. The catwalk may be coupled to a base of the HVAC units via a base rail and/or lifting lugs of the base. Particularly, the base of the HVAC unit may fully support the weight of the catwalk. In this manner, the catwalk may be standardized to fit rooftop units disposed on a variety of different building roofs. Moreover, due to the standardization of the catwalk and integration of the catwalk with the HVAC unit, the catwalk may be attached to the rooftop HVAC unit prior to installation of the rooftop HVAC unit on a building, thereby increasing efficiency of installation.

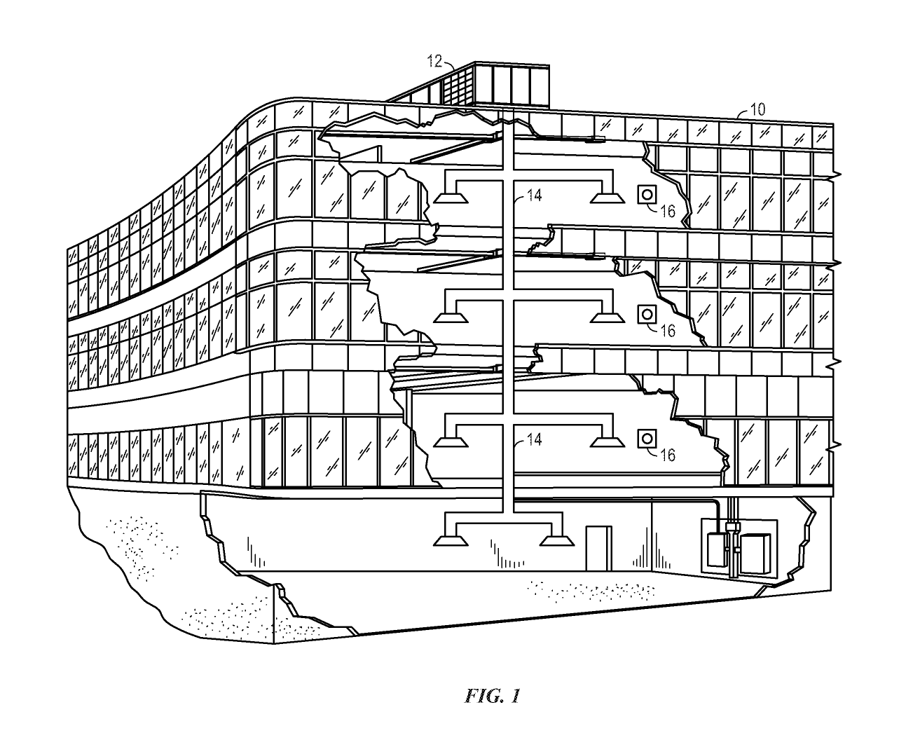

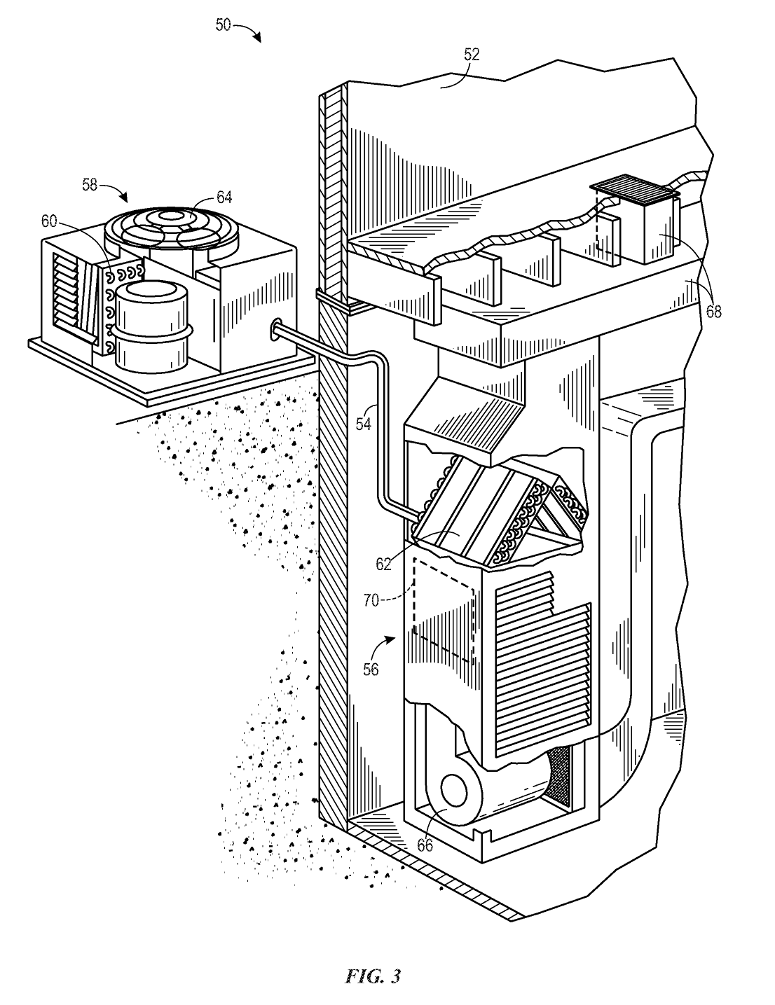

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

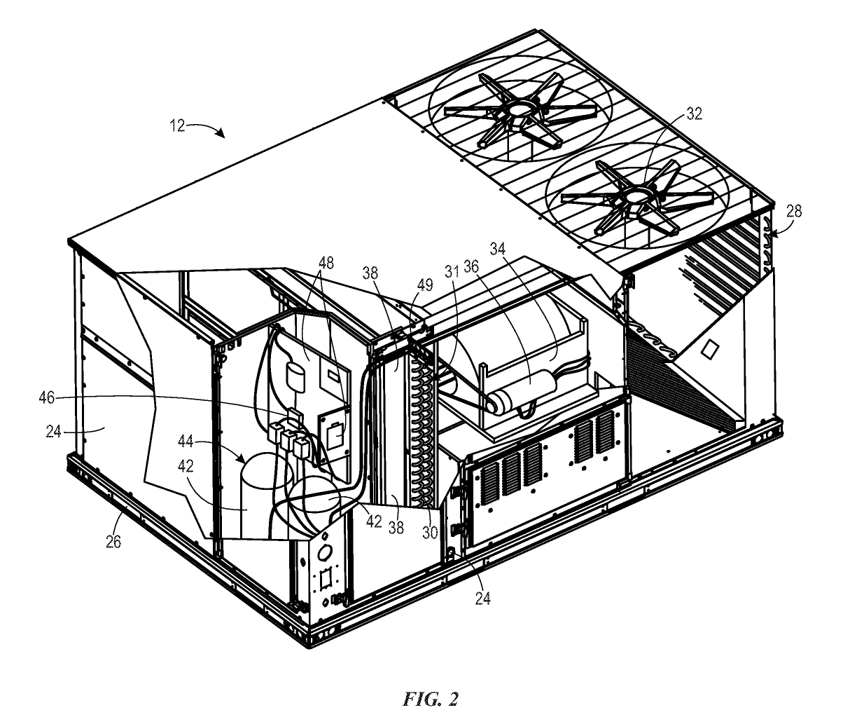

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant (which may be expanded by an expansion device, not shown) and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or the set point plus a small amount, the residential heating and cooling system 50 may become operative to refrigerate additional air for circulation through the residence 52. When the temperature reaches the set point, or the set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

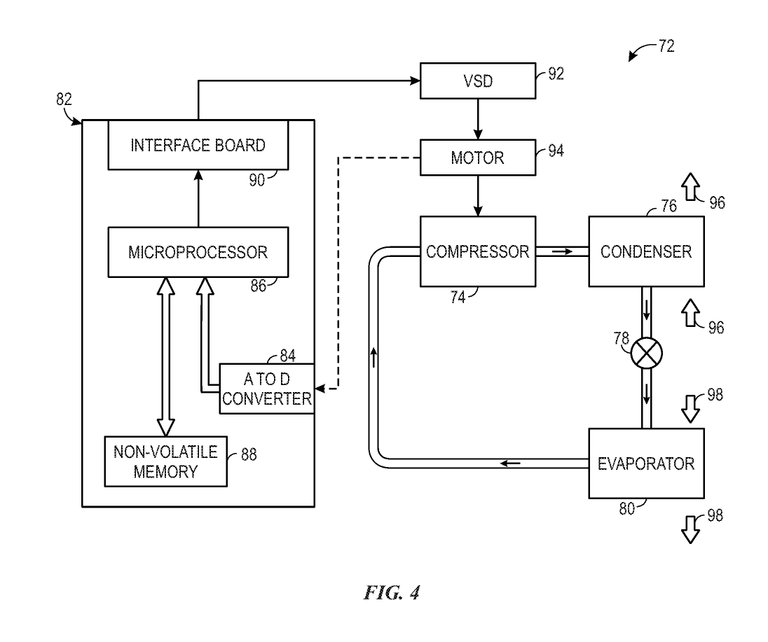

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 38 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

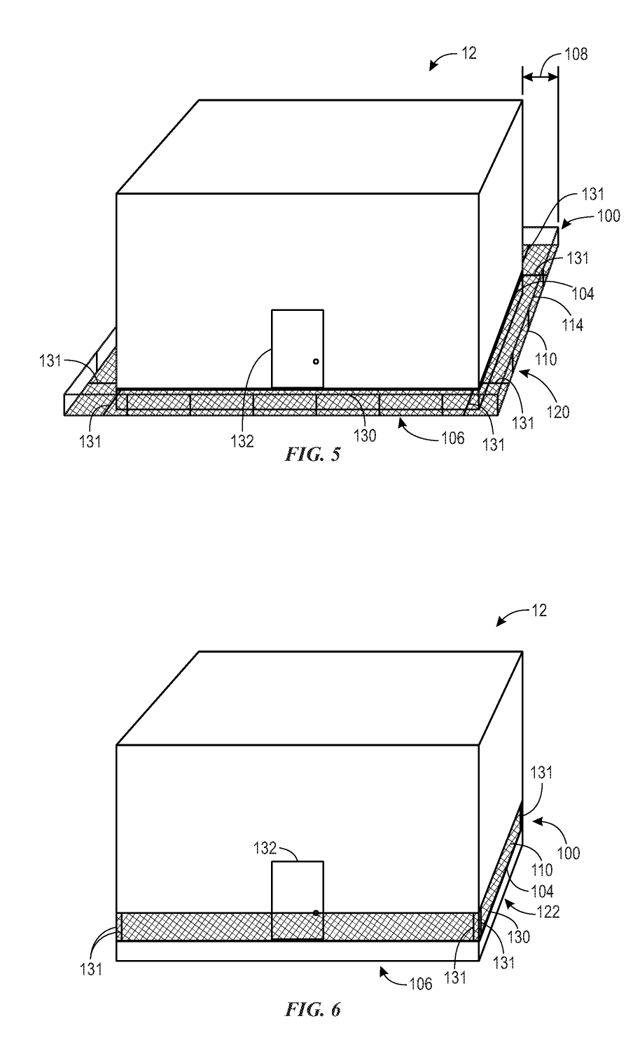

As discussed below, an HVAC unit, such as the HVAC unit 12, may include a catwalk, or elevated platform, coupled to a base of the HVAC unit, which may fully support the weight of the catwalk. In certain embodiments, the catwalk may be disposed in a folded-up, retracted, or travel, position and transitioned to a folded-down, deployed, or operational position, or vice versa. For example, FIG. 5 is a perspective view of the HVAC unit 12 that includes a catwalk 100 coupled to an attachment element 104 of the HVAC unit 12. The attachment element 104 may be disposed generally adjacent to, or at, a base 106 of the HVAC unit 12. In certain embodiments, the attachment feature 104 may be a rail, such as the rails 26 (FIG. 2), lifting lugs, a frame, a platform, or any other suitable structure that is configured to support the weight of HVAC unit 12. Indeed, in certain embodiments, the attachment element 104 may be a heavy steel base which may be suitable for supporting the HVAC unit 12 during transportation and installation of the HVAC unit 12. As shown, the catwalk 100 may be cantilevered to the HVAC unit 12 at the attachment element 104. That is, the catwalk 100 may be rigidly and integrally coupled to the attachment element 104, and the attachment element 104 may fully support the weight of the catwalk 100. In certain embodiments, the catwalk 100 may be bolted and/or welded to attachment element 104. The catwalk 100 may laterally extend a width 108 of approximately three feet from the attachment element 104 to provide sufficient room for at least one person to move about the perimeter of the HVAC unit 12 via the catwalk 100. In other embodiments, the catwalk 100 may extend any suitable distance from the side of the HVAC unit 12 to support any suitable number of persons across the width 108. Keeping this in mind, the catwalk 100 may include a platform 110, such as grating, or any other suitable platform type, on which persons may stand or walk. As discussed below, the platform 110 may be integral to the catwalk 100 and/or may be detachable. In certain embodiments, the HVAC unit 12 may be disposed on a curb of a roof of a building, or elevated in some other manner from the roof of the building. Accordingly, in certain embodiments, the platform 110 may be at approximately the same elevation as the attachment element 104 to which the catwalk 100 is coupled.

In certain embodiments, the catwalk 100 may be equipped with handrails 114. The handrails 114 may provide for containment and/or stability for persons while on the platform 110 of the catwalk 100. For example, the handrails 114 may be coupled to the catwalk 100 at an edge of the catwalk 100 and may be disposed substantially perpendicular to the platform 110 of the catwalk 100.

Further, in certain embodiments, the catwalk 100 may be configured to transition between a folded-down or deployed state 120 as shown in FIG. 5, and a folded-up or retracted state 122, as shown in FIG. 6. That is, the catwalk 100 may pivot, or be folded, towards the HVAC unit 12 while being transitioned from the deployed position 120 to the retracted position 122 and may pivot, or be folded, away from the HVAC unit 12 while being transitioned from the retracted position 122 to the deployed position 120. For example, as shown in FIG. 6, the catwalk 100 may rotate about a hinge 130 to be in the retracted state 122 for transportation purposes and to be in the deployed state 120 for operation purposes, as discussed in further detail below. Indeed, the HVAC unit 12 and the equipped catwalk 100 may transport more easily with a decreased footprint as a result of the catwalk 100 being in the retracted state 122. Particularly, while in the retracted state 122, the catwalk 100 may be disposed substantially vertically to decrease an overall footprint of the HVAC unit. However, while in the deployed state 120, the catwalk 100 may be disposed substantially horizontally to provide for persons to walk on the catwalk 100. In certain embodiments, the hinge 130 may utilize a quick release mechanism, such as a button or pin, which is configured to lock the hinge 130 in either the retracted state 122 or the deployed state 120, and easily disengage to allow the catwalk 100 to move between the retracted state 122 and the deployed state 120. For example, in certain embodiments, the hinge 130 may utilize a pin, such as a clevis pin, a cotterless pin, or self-locking rapid release pin, or any other suitable quick release mechanism to help in switching between the retracted state 122 and the deployed state 120, as described herein. In certain embodiments, the hinge 130 may be hydraulically or electrically actuated via an actuation mechanism.

Furthermore, in some embodiments, portions of the catwalk 100 may be integrally coupled to the HVAC unit 12, while other portions may be detachable. For example, referring to FIGS. 5 and 6, supports may be coupled to the attachment element 104 via the hinge 130. The supports 131 may be configured to rotate between the deployed position 120 and the retracted position 122, as described above. Further, the platform 110 may be formed of detachable components that are configured to couple to the supports 131 when the supports 131 are in the retracted position 122. Therefore, when installing the HVAC unit 12, a user may simply rotate the supports 131 to the retracted position 122 and couple the platforms 110 to the supports 131 via hooks, latches, or any other suitable attachment device. Other elements, such as the hand rails 114, may also be easily coupled to the supports 131 once in the retracted position 122.

Moreover, the catwalk 100 may provide access to an exterior surface of the HVAC unit 12. Indeed, the HVAC unit 12 may include a panel 132, or door, which may provide access to internal components of the HVAC unit 12. Particularly, as shown, the catwalk 100 may provide easy access to the panel 132 such that service personnel may easily service the HVAC unit 12. As discussed below, in certain embodiments, the catwalk 100 may also provide access to a panel 132, or door, that is disposed on the roof of the HVAC unit 12.

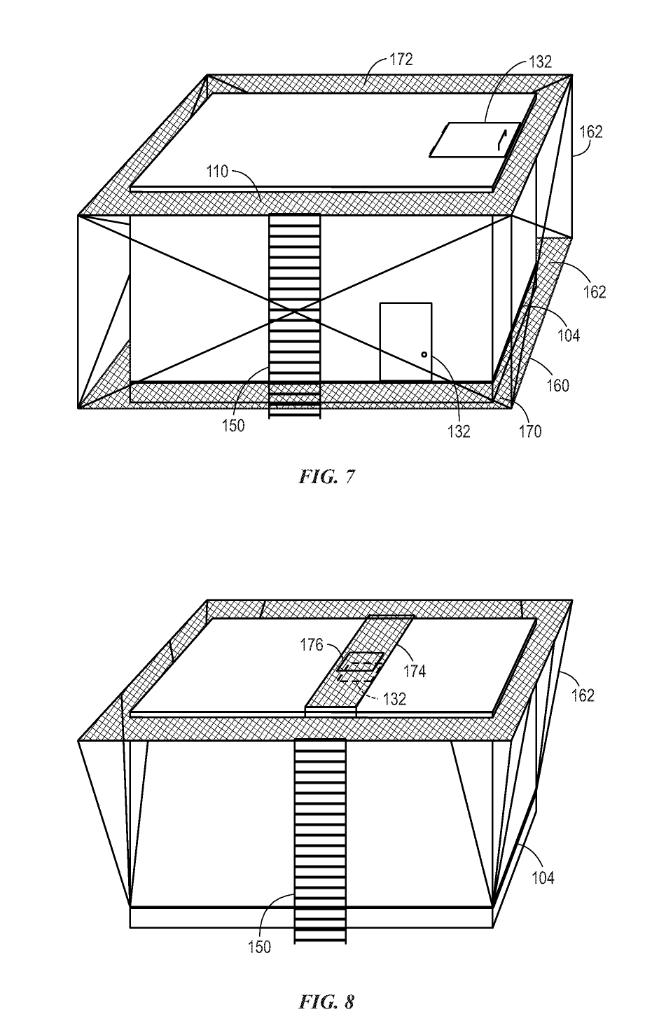

FIG. 7 is a perspective view of an embodiment of the catwalk 100 coupled to the HVAC unit 12. As shown, in certain embodiments, the catwalk 100 may include a ladder 150 which may extend from the platform 110 of the catwalk 100 to a surface of the roof of a building, or to another easily accessible surface. As discussed above, in some embodiments, the catwalk 100 may provide access to one or more panels 132, or doors, which may be disposed on the roof of the HVAC unit 12. In this manner, service personnel, or technicians may be provided with easy access to internal components of the HVAC unit 12 from the roof of the HVAC unit 12.

Moreover, the catwalk 100 may be at an elevated position above the attachment element 104, and generally adjacent to, or at, the top of the HVAC unit 12. For example, as shown, in FIG. 7, the catwalk 100 may be supported from a base frame 160 that is cantilevered horizontally from the attachment element 104 of the HVAC unit 12. From the base frame 160, a plurality of support members 162, such as beams, poles, or any other suitable structure may support the platform 110 adjacent to a top of the HVAC unit 12. Further, in certain embodiments, the catwalk 100 may include multiple levels of the platform 110. For example, the catwalk 100 may include a first platform 170 disposed at an elevation that is at approximately the same height as the attachment element 104 and a second platform 172 that is disposed generally adjacent to a top of the HVAC unit 12. Therefore, service personnel may access the HVAC unit 12 from multiple levels.

In certain embodiments, as shown in FIG. 8, the catwalk 100 may include an overhead platform 174. From the overhead platform 174, service personnel may access the HVAC unit 12 from a vertical direction. To this end, in certain embodiments, the overhead platform 174 may include a hatch 176 that may open to provide access to the panel 132 disposed substantially directly below the hatch 176 of the overhead platform 174. In some embodiments, the panel 132 may be positioned a side of the overhead platform 174. In this manner, service personnel may have direct access to a roof of the HVAC unit 12 without walking on the roof of the HVAC unit 12. Also, as shown in FIG. 8, in certain embodiments, the support members 162 may support the platform 110 of the catwalk 100 via direct attachment to the attachment element 104, such as without the use of the base frame 160 (FIG. 7).

In some embodiments, the catwalk 100 may be formed from detachable components that are configured to easily attach to the attachment element 104. Therefore, in certain embodiments, the catwalk 100 may be transported as separate pieces from the HVAC unit 12. The catwalk 100 may then be attached to the attachment element 104 through any suitable fastening means, such as bolting. Indeed, the catwalk 100 may easily couple to the HVAC unit 12 regardless of the surrounding environment provided by the roof of the building. For example, the platforms 110, the base frame 160, the support members 162, the overhead platform 174, and other features may easily be attached and detached from the HVAC unit 12, and more specifically, from the attachment element 104.

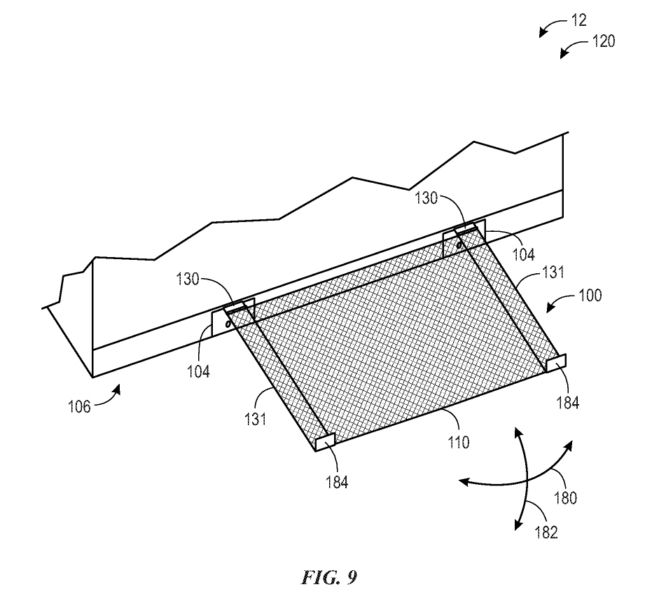

FIG. 9 is a perspective view of an embodiment of the catwalk 100, which may be utilized in any of the embodiments discussed in FIGS. 5-8 above. Particularly, FIG. 9 is a perspective view of the platform 110 coupled to the supports 131, which are in turn coupled the base 106 of the HVAC unit 12 via the attachment feature 104. As shown, the supports 131 may be rigidly and/or integrally coupled to the attachment feature 104 via bolting, welding, or any other suitable attachment method. Further, it should be understood that the embodiments shown in FIG. 9 may represent only a portion of the catwalk 100, which, in certain embodiments, may be disposed about a portion, or an entirety, of a perimeter of the base 106. As shown, in certain embodiments, the supports 131 may include the hinge 130. The hinge 130 may be disposed such that the supports 131 may rotate in a horizontal direction 180. That is, the supports 131 may be folded in the horizontal direction 180 such that the supports 131 are rotated to be disposed substantially along a perimeter of the base 106 when in the retracted position 122. Alternatively, the hinge 130 may be disposed such that the supports 131 may rotate in a vertical direction 182. That is, the supports 131 may be folded in the vertical direction 182 such that the supports 131 are rotated to be disposed substantially vertically, or perpendicular to the perimeter of the base 106 when in the retracted position 122. Moreover, the supports 131 may include one or more flanges 184 disposed at one or more edges of the supports 131. The flanges 184 may be utilized to guide the platform 110 into a suitable location when coupling the platform 110 to the supports 131. Specifically, in certain embodiments, the platform 110 may rest vertically atop the supports 131 and/or may be rigidly coupled to the supports 131 such as by bolting or welding.

Accordingly, the present disclosure is directed to providing systems and methods for an elevated catwalk for a rooftop HVAC unit. The catwalk may be coupled to and fully supported by a base of the HVAC unit via a base rail and/or lifting lugs. Particularly, the catwalk may be fully supported by the HVAC unit without interacting with, or directly relying on, a roof on which the rooftop HVAC unit is disposed. In this manner, the catwalk may be easily assembled and utilized without first having to customize the catwalk for the roof of the building. Moreover, the catwalk may transition between a retracted state, which may result in a decreased footprint for transportation purposes, and a deployed state, for operation purposes. Overall, the catwalk may provide for easy access to components of the HVAC unit for installation and maintenance of the HVAC unit.

While only certain features and embodiments of the present disclosure have been illustrated and described, many modifications and changes may occur to those skilled in the art, such as variations in sizes, dimensions, structures, shapes and proportions of the various elements, values of parameters, such as temperatures or pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the present disclosure. Furthermore, in an effort to provide a concise description of the exemplary embodiments, all features of an actual implementation may not have been described, such as those unrelated to the presently contemplated best mode of carrying out the present disclosure, or those unrelated to enabling the claimed embodiments. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A rooftop heating, ventilating, and air conditioning (HVAC) apparatus, comprising:
a catwalk pivotally attached to the HVAC apparatus such that the catwalk is configured to be folded toward the HVAC apparatus.

2. The rooftop HVAC apparatus of claim 1, wherein the apparatus has a first footprint when the catwalk is pivoted in such a manner that it is folded away from the HVAC apparatus, and a second, smaller footprint when the catwalk is pivoted such that it is folded toward the HVAC apparatus.

3. The rooftop HVAC apparatus of claim 1, wherein the HVAC apparatus comprises a base and the catwalk is attached to the base.

4. The rooftop HVAC apparatus of claim 1, wherein the catwalk pivots to be disposed substantially vertically against the HVAC apparatus.

5. The rooftop HVAC apparatus of claim 1, wherein the base of the HVAC apparatus comprises a rail and the catwalk is attached to the rail.

6. The rooftop HVAC apparatus of claim 1, further comprising lifting lugs.

7. The rooftop HVAC apparatus of claim 1, wherein a width of the catwalk is approximately three feet.

8. The rooftop HVAC apparatus of claim 1, wherein the HVAC unit is disposed on a roof of a building, and wherein the catwalk further comprises a ladder extending between the roof and the catwalk.

9. The rooftop HVAC apparatus of claim 1, wherein the catwalk comprises an overhead portion configured to extend over a roof of the HVAC unit.

10. The rooftop HVAC apparatus of claim 1, wherein the catwalk is a first catwalk disposed adjacent to the base of the HVAC unit, and wherein the HVAC unit comprises a second catwalk disposed adjacent to a roof of the HVAC unit.

11. The rooftop HVAC apparatus of claim 1, wherein the catwalk comprises a platform disposed adjacent to a roof of the HVAC unit, and wherein the platform is supported by support members coupled to the attachment feature.

12. A heating, ventilating, and air conditioning (HVAC) system, comprising:
an HVAC apparatus;
a catwalk configured to couple to a base of the HVAC unit, comprising:
a plurality of platforms; and
a plurality of support members pivotally coupled to the HVAC apparatus and configured to couple the plurality of platforms to the HVAC apparatus.

13. The HVAC system of claim 12, wherein the plurality of support members is configured to couple the plurality of platforms to a base rail of the HVAC apparatus.

14. The HVAC system of claim 12, wherein the plurality of support members is configured to couple the plurality of platforms to a plurality of lifting lugs of the HVAC apparatus.

15. The HVAC system of claim 12, wherein the HVAC unit is configured to support an entire weight of the catwalk.

16. The HVAC system of claim 15, wherein the base of the HVAC unit is configured to support the entire weight of the catwalk.

17. The HVAC system of claim 12, wherein the plurality of platforms and/or the plurality of support members are configured to pivot from a retracted position to a deployed position.

18. A heating, ventilating, and air conditioning (HVAC) system, comprising:
an HVAC apparatus comprising a base;
a catwalk coupled to the base of the HVAC apparatus, wherein the catwalk is configured to be pivoted between a first position and a second position about a hinge coupled to the base.

19. The HVAC system of claim 18, wherein a walkway of the catwalk is disposed substantially horizontally while in the first position.

20. The HVAC system of claim 18, wherein a walkway of the catwalk is disposed substantially vertically while in the second position.

21. The HVAC system of claim 18, comprising a quick-release mechanism, wherein the quick-release mechanism is configured to lock the catwalk in the first position and/or the second position.

22. The HVAC system of claim 21, wherein the quick-release mechanism comprises a pin to lock and unlock the catwalk to and from the first and second positions.

23. The HVAC system of claim 18, wherein the catwalk is configured to extend laterally from the base of the HVAC apparatus while in the first position.

24. The HVAC system of claim 18, wherein the catwalk comprises a detachable platform, a handrail, a support member, or any combination thereof.
